(19) United States
(12) Patent Application Publication
(10) Pub. No.: US 2022/0230077 A1
(43) Pub. Date: Jul. 21, 2022

(54) Machine Learning Model Wildfire Prediction

(71) Applicant: INTERNATIONAL BUSINESS MACHINES CORPORATION, Armonk, NY (US)

(72) Inventors: Zia K. Mohammad, Austin, TX (US); Indervir Singh Banipal, Austin, TX (US); Shikhar Kwatra, San Jose, CA (US); Nadiya Kochura, Bolton, MA (US)

(21) Appl. No.: 17/152,351

(22) Filed: Jan. 19, 2021

(51) Int. Cl. G06N 5/04; G06N 20/00

(52) U.S. Cl. CPC G06N 5/04; G06N 20/00

(57) ABSTRACT

Aspects of the disclosure provide for a computer-implemented method. In at least some examples, the method includes receiving one or more piece of historical data associated with one or more occurrences of wildfires, training a machine learning model according to the received one or more historical data, receiving one or more piece of substantially real-time data associated with a region of interest, and processing the received one or more piece of substantially real-time data using the machine learning model to determine the probability of the wildfire occurring.

### STATEMENT REGARDING FEDERALLY SPONSORED RESEARCH OR DEVELOPMENT

Not applicable.

### STATEMENT REGARDING PRIOR DISCLOSURES BY THE INVENTOR OR A JOINT INVENTOR

Not applicable.

### BACKGROUND

The present disclosure relates to the field of machine learning and machine learning model training and processing.

Power systems may be broken up into grids or micro-grids. Each of these micro-grids have towers which hold the power lines. In the event of the tower falling or a grid failing, a fire can occur, such as from electrical discharge associated with the power lines or transformers. Some technologies may aid in predicting such failure and/or fires.

### SUMMARY

Aspects of the disclosure provide for a computer program product for prediction of a probability of a wildfire occurring. In at least some examples, the computer program product includes a computer readable storage medium having program instructions embodied therewith. The program instructions are executable by a processor to cause the processor to receive one or more piece of historical data associated with one or more occurrences of wildfires, train a machine learning model according to the one or more piece of historical data, receive one or more piece of substantially real-time data associated with a region of interest, and process the one or more piece of substantially real-time data using the machine learning model to determine the probability of the wildfire occurring.

Other aspects of the disclosure provide for a computer-implemented method. In at least some examples, the method includes receiving one or more piece of historical data associated with one or more occurrences of wildfires, training a machine learning model according to the one or more piece of historical data, receiving one or more piece of substantially real-time data associated with a region of interest, and processing the one or more piece of substantially real-time data using the machine learning model to determine the probability of the wildfire occurring.

Other aspects of the disclosure provide for a machine learning system. In at least some examples, the machine learning system includes a processor configured to receive one or more piece of historical data associated with one or more occurrences of wildfires, train a machine learning model according to the one or more piece of historical data, receive one or more piece of substantially real-time data associated with a region of interest, and process the one or more piece of substantially real-time data using the machine learning model to determine the probability of the wildfire occurring.

### BRIEF DESCRIPTION OF THE DRAWINGS

FIG. 1 depicts a block diagram of a machine learning system according to various embodiments

FIG. 2 depicts a flowchart of a method for machine learning model training according to various embodiments.

FIG. 3 depicts a flowchart of a method for wildfire prediction according to various embodiments.

FIG. 4 depicts a computing device according to various embodiments.

FIG. 5 depicts a cloud computing environment according to various embodiments.

FIG. 6 depicts abstraction model layers according to various embodiments.

### DETAILED DESCRIPTION

Various systems, such as utilities, may be divided into various divisions. For example, the power grid of a country, a state, or other locale may be divided into grids or micro-grids. Each grid or sub-grid may be controllable, such that one sub-grid may be turned off without turning off another sub-grid, one grid may be turned off without turning off another grid, etc. Sometimes, wildfires may begin as a result of an energized power grid in combination with certain environmental factors. These environmental factors can include humidity, temperature, wind, the existence or lack of recent precipitation, moisture saturation of soil, the occurrence of lightning, the existence of excessive dead foliage, the existence of excessive organic, flammable underbrush (whether dead or alive), etc. By monitoring at least some of these environmental factors and analyzing them in the context of historical occurrences of wildfire, a probability of an upcoming wildfire may be predicted. Based on that prediction, certain recommendations may be made or actions taken. For example, a recommendation to a power grid operator or other entity may be generated and provided to de-energize a power grid. Alternatively, a power grid may be automatically de-energized based on the probability exceeding a certain threshold and with opt-in of the power grid operator to automatic control based on wildfire probability prediction.

Disclosed herein are embodiments that provide for a machine learning system that predicts the probability of wildfires. In at least some examples, the machine learning system includes autoencoders that train the machine learning system based on historical data. The auto encoders are, in some examples, neural networks. The historical data may be data for locations in which wildfires have occurred, such as environmental data indicating weather conditions that precipitated the wildfires, information related to the condition of power grids near which the wildfires occurred, etc. Based on the historical data, the autoencoders may determine factors which most contributed to the wildfires occurring, such as a particular combination of weather conditions, weather patterns, and/or power grid conditions. The factors may be region specific, such as to a portion of a state (e.g., such as a county), a region defined by a zip code, a state, a portion of a country, a country, a continent, a hemisphere, etc. In at least some examples, the training is an ongoing process to address and account for evolution over time in the factors which most contributed to the wildfires occurring, changing climates, etc.

The trained machine learning system may process substantially real-time data from multiple sources to predict a probability of a fire occurring in a particular region, for a particular power grid (or sub-grid), etc. As used herein, substantially real-time data may include data which has been generated within a threshold amount of time of the machine learning processing occurring, sensor data which has been captured within a threshold amount of time of the machine learning processing occurring, data that predicts weather conditions (e.g., weather forecasts) The substantially real-time data may include image data provided by satellites, image data provided by helicopter mounted cameras, airplane mounted cameras, drone aircraft mounted cameras, weather satellites, sensors that monitor and/or determine weather conditions or conditions of the power grid, etc. In at least some examples, the substantially real-time data may also include photographs or videos mined from publicly available Internet sources, such as social media sites, when the photographs or videos are geolocation tagged to a particular region of interest or region for which the machine learning system is performing processing. The machine learning system processes and analyzes the substantially real-time data to determine whether a combination of conditions represented in the substantially real-time data matches a pattern of data values determined via the training to have a high probability for creating a wildfire. The machine learning system may determine the probability based on a percentage of data points of the substantially real-time data that match, or are within a threshold variance of, the values of corresponding data points determined via the training to have a high probability for creating a wildfire. When the probability exceeds a programmed threshold, the machine learning system may generate an alert, or take other action, indicating a risk of a wildfire occurring and/or in an effort to mitigate occurrence of the predicted wildfire. In some examples, the machine learning system determines the probability of a wildfire occurring for a region based on training data from that region. In other examples, the machine learning system determines the probability of a wildfire occurring for a region based on training data from that region and/or one or more other regions that share similarities with the region for which the wildfire prediction is performed.

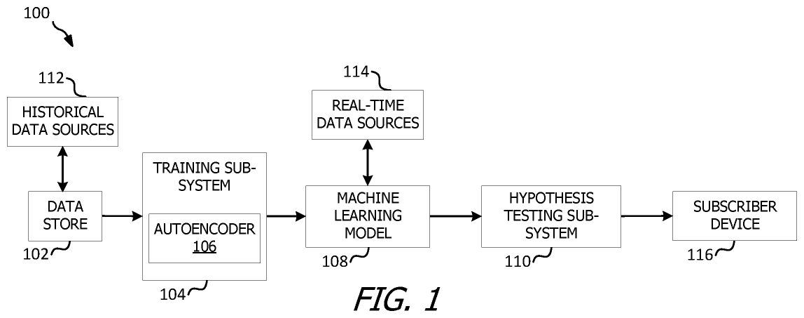

With reference now to FIG. 1, a block diagram of a machine learning system 100 for determining a probability of a wildfire occurring according to various embodiments is shown. In at least some examples, the system 100 includes a data store 102, a training sub-system 104, including an autoencoder 106, that determines, or trains, and provides a machine learning model 108, and a hypothesis testing sub-system 110. The machine learning system 100 is, in at least some examples, communicatively coupled and configured to receive data from historical data sources 112 and real-time data sources 114. The machine learning system 100 is also, in at least some examples, communicatively coupled and configured to provide a machine learning model processing result to a subscriber device 116. The subscriber device 116 may be any device which may subscribe to or request wildfire predictions from the machine learning system 100. While one data store 102 is shown in FIG. 1, in various examples any number of data stores may be included in the system 100. Additionally, the data store 102 may be sub-divided into one or more portions. In some examples, the machine learning system 100 may have a data store 102, or a portion of the data store 102, for each geographic region for which the machine learning system 100 may determine wildfire predictions.

In an example of operation of the machine learning system 100, historical data is retrieved or obtained from the historical data sources 112 and stored in the data store 102. In at least some examples, the historical data includes data points corresponding to wildfire occurrences, as described above. Thus, the data points of the historical data may include weather data, power grid data, environmental data, etc. In at least some examples, the historical data may be obtained from historical data sources 112 that are trusted or verified, such as governmental sources that have captured and/or aggregated the historical data. The training sub-system 104 may process the historical data stored in the data store 102 to perform data pruning. The data pruning may map the historical data to specific regions of interest, such as states, zip codes, counties, countries, etc. The training sub-system 104 may generate a HashMap for each region of interest, where the HashMap includes key-value pairs for historical data points corresponding to the region of interest. In at least some examples, each HashMap may be considered a location-specific bucket that includes the historical data for that location.

For each HashMap, the autoencoder 106 performs feature selection. The autoencoder 106, in at least some examples, performs unsupervised learning. The feature selection, in at least some examples, implements a neural network to process and analyze each HashMap. The feature selection, in at least some examples, determines which of the historical data points (e.g., as represented as key-value pairs in the HashMap) are most responsible for causing an occurrence of a wildfire. In at least some examples, the feature that is most responsible for causing an occurrence of a wildfire is determined based on a weighting of the features included in the HashMap, where a highest weighted feature is the feature that is most responsible for causing an occurrence of a wildfire. The weighting may follow any suitable weighting scheme, the scope of which is not limited herein. For the features determined to be most responsible for causing an occurrence of a wildfire, the training sub-system 104 trains the machine learning model 108. The training sub-system 104 may train the machine learning model 108 according to any suitable process, the scope of which is not limited herein. For example, the training sub-system 104 may train the machine learning model 108 according to logistic regression, an artificial neural network, a support-vector machine, a decision tree, or any other suitable process or training model.

Subsequent to formation of the machine learning model 108, the machine learning system 100 may process data through, or via, the machine learning model. For example, the machine learning system 100 may receive substantially real-time data, as described above, from the real-time data sources 114. The machine learning system 100 may process the substantially real-time data through the machine learning model 108 to determine similarities between the features determined to be most responsible for causing an occurrence of a wildfire, in a region to which the substantially real-time data corresponds. The machine learning system 100 may also process the substantially real-time data through the machine learning model 108 to determine similarities between the features determined to be most responsible for causing an occurrence of a wildfire, in a region similar to the region to which the substantially real-time data corresponds. For example, the machine learning system 100 may perform federated learning in which historical data corresponding to locations that are similar to a region corresponding to the substantially real-time data is used, in addition to historical data from the region corresponding to the substantially real-time data, in analyzing the substantially real-time data.

The similarity may be an exact match, or a value match within a threshold variance (e.g., a value match within about 25% variance, about 20% variance, about 15% variance, about 10% variance, about 5% variance, etc.). When the machine learning model 108 determines a match between a programmed number of substantially-real time data points and the features determined to be most responsible for causing an occurrence of a wildfire, the machine learning model 108 may determine that it is probable that a wildfire may occur (e.g., a wildfire is imminent and/or conditions are probable for the occurrence of a wildfire). In some examples, the machine learning model 108 may provide a result or prediction of wildfire in a binary format, indicating either that a fire is probable or a fire is not probable. In other examples, the machine learning model 108 may provide the result or prediction as a percentage in a range of 0 to 100, where a larger value indicates a higher probability of a wildfire occurring.

In some examples, the output or prediction of the machine learning model 108 may be provided to the subscriber device 116. For example, the output or prediction may be provided as a notification conveying the output or prediction of the machine learning model 108 to the subscriber device 116. In other examples, the machine learning system 100 may take direct action based on the output or prediction of the machine learning model 108. Such action may include, for example, controlling a power grid or other utility resource to de-energize to mitigate occurrence of the predicted wildfire. In other examples, the output or prediction of the machine learning model 108 is provided to the hypothesis testing sub-system 110. In at least some examples, the hypothesis testing sub-system 110 implements a probabilistic model that performs hypothesis testing to determine a recommended action. The probabilistic model may be, for example, statistical hypothesis testing or binomial testing. In at least some examples, the recommended action determined by the hypothesis testing sub-system 110 may be provided as a notification conveying the recommended action to the subscriber device 116. In other examples, the machine learning system 100 may take direct action based on the recommended action. Such recommended action may include, for example, controlling a power grid or other utility resource to de-energize to mitigate occurrence of the predicted wildfire.

In at least some examples, the predictive model implemented by the hypothesis testing sub-system 110 includes feature extraction from images or video included in the substantially real-time data. For example, the predictive model may determine a color of invasive grasses appearing in the images or videos and/or an extensiveness of area with dead plants shown in the images or video. For example, the machine learning model 108 may determine that a fire is probable and provide that determination to the hypothesis testing sub-system 110. However, because of the region in which the wildfire is probable, the hypothesis testing sub-system 110 may determine that there is a low likelihood of the wildfire becoming uncontrolled, may determine that no action is available to mitigate chances of the wildfire occurring, may determine that there is limited to no fuel available in the region in which the wildfire is predicted to occur, etc. The hypothesis testing sub-system 110 may make that determination based in part on the feature extraction from images or video included in the substantially real-time data. For example, invasive grasses may not anchor well in soil and may ignite more easily than other underbrush, better fueling wildfires. Similarly, extensive presence of dead underbrush or plants may contribute to a higher chance of a wildfire occurring. Thus, by extracting and considering features from images or video included in the substantially real-time data, the hypothesis testing sub-system 110 may account for these features in determining the recommended action.

In at least some examples, the machine learning system 100 may include feedback, such as to refine the machine learning model 108. Refining the machine learning model 108 may increase accuracy of the machine learning model 108. In at least some examples, in addition to receiving the historical data, the training sub-system 104 also receives the substantially real-time data from the real-time data sources 114. Some amount of time after the machine learning model 108 provides the prediction of a wildfire occurring, the training sub-system 104 may also receive feedback regarding the prediction. The feedback may be, for example, received as input provided by authorized authorities (e.g., a governmental body, fire officials, etc.) or may be obtained automatically by the machine learning system 100. For example, in some implementations the machine learning system 100 may analyze available data sources such as the Internet to determine an accuracy of the prediction. The analysis may be an image analysis of image data from an area in which the wildfire was predicted to occur, crawling of social media sites, new sites, etc. Based on the feedback and the substantially real-time data, and in some examples, the prediction determined by the machine learning model 108 for that specific substantially real-time data, the training sub-system 104 may further refine the machine learning model 108 to increase accuracy of the machine learning model.

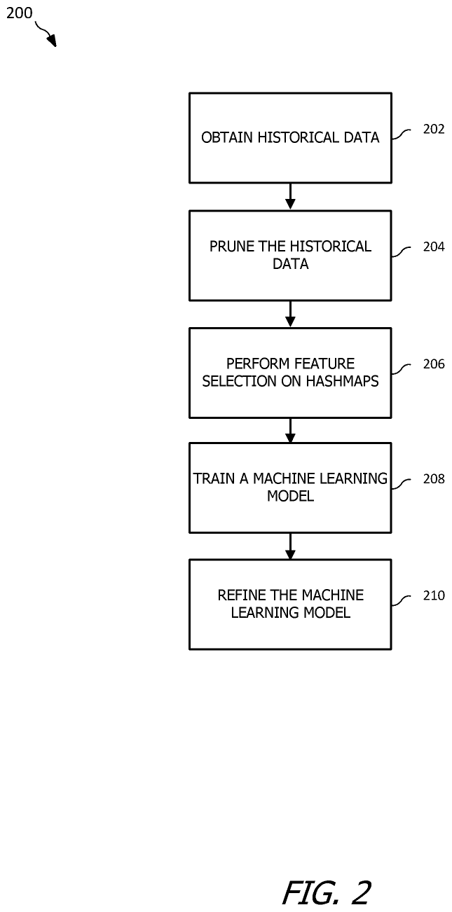

With reference now to FIG. 2, a flowchart of a method 200 for machine learning model training according to various embodiments is shown. In at least some examples, the method 200 is implemented by a machine learning system such as the machine learning system 100 of FIG. 1 to train the machine learning model 108, also of FIG. 1. The method 200 may be implemented to train the machine learning model 108, in some examples, to facilitate subsequent data processing and/or analysis according to the machine learning model 108.

At operation 202, historical data is obtained. The historical data may be obtained from any suitable source, the scope of which is not limited herein. In at least some examples, the historical data is obtained for a single geographic region. In other examples, the historical data is obtained for multiple geographic regions. In some examples, the historical data may be obtained from any suitable source. In other examples, the historical data may be obtained only from trusted sources from which a degree of accuracy of the historical data is known or can be assumed. In some examples, trusted sources may be government databases.

At operation 204, the historical data is pruned. In at least some examples, the pruning is performed by the machine learning system to map the historical data to particular regions. The regions may be of any granularity specified by the machine learning system, as described above, and data points of the historical data may be may assigned to multiple regions (e.g., such of increasing or decreasing granularity or locality). To prune the historical data, the machine learning system may generate a HashMap for each region of interest. The HashMap may be a table of key-value pairs that include an identification of a data point from the historical data for the region of interest represented by the HashMap and a value of that data point for the region of interest represented by the HashMap. For example, a first HashMap may exist for northern California and a second HashMap may exist for southern California. Similarly, other HashMaps may exist for other states, or portions of states, zip codes, counties, countries, continents, etc.

At operation 206, feature selection is performed on each HashMap. In at least some examples, the machine learning system implements one or more autoencoders to perform the feature selection. In at least some examples, the autoencoders implement a neural network to perform the feature selection. Via the feature selection, in at least some examples, the autoencoders learn which features in a HashMap under analysis are most responsible for causing an occurrence of a wildfire.

At operation 208, a machine learning model is trained. In at least some examples, the machine learning system trains the machine learning model based on the features determined at operation 206 to be most responsible for causing an occurrence of a wildfire. The machine learning model may be trained according to any suitable process, the scope of which is not limited herein. For example, the machine learning model may be trained according to logistic regression, an artificial neural network, a support-vector machine, a decision tree, or any other suitable process or training model.

At operation 210, in some examples, the machine learning model is refined based on feedback. Refining the machine learning model may increase accuracy of the machine learning model. For example, the machine learning system may receive feedback indicating an accuracy of a prediction determined based on the machine learning model trained at operation 208. The feedback may be, for example, received as input provided by authorized authorities (e.g., a governmental body, fire officials, etc.) or may be obtained automatically by the machine learning system. For example, in some implementations the machine learning system may analyze available data sources such as the Internet to determine an accuracy of the prediction. The analysis may be an image analysis of image data from an area in which the wildfire was predicted to occur, crawling of social media sites, new sites, etc. Based at least in part on the feedback, the machine learning model may be validated for accuracy and/or effectiveness. Also based at least in part on the feedback, the machine learning model may be refined to increase accuracy and/or effectiveness of the machine learning model.

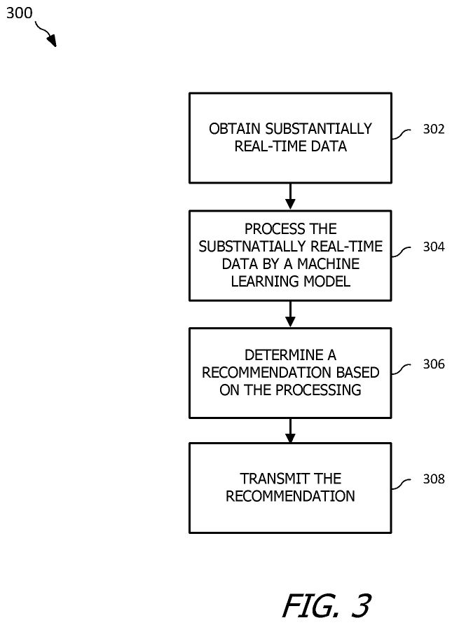

With reference now to FIG. 3, a flowchart of a method 300 for wildfire prediction according to various embodiments is shown. In at least some examples, the method 300 is implemented by a machine learning system such as the machine learning system 100 of FIG. 1 to train the machine learning model 108, also of FIG. 1. The method 300 may be implemented to predict a probability of a wildfire occurring, such as based on a machine learning model.

At operation 302, substantially real-time data is obtained. The substantially real-time data may be obtained from any suitable source, the scope of which is not limited herein. In at least some examples, the substantially real-time data is obtained for a particular geographic region of interest, such as for which a subscriber has subscribed to receive wildfire predictions. The substantially real-time data may be obtained from any suitable source. In at least some examples, the substantially real-time data is aggregated from multiple sources, such as weather forecasts, sensor readings, video or image data of the particular geographic region, etc.

At operation 304, the substantially real-time data is processed by a machine learning model. In at least some examples, the machine learning model is the machine learning model trained according to the method 200 of FIG. 2. The machine learning system may process the substantially real-time data through the machine learning model to determine similarities between the features determined to be most responsible for causing an occurrence of a wildfire, as represented in the machine learning model, for the particular geographic region corresponding to the substantially real-time data. The machine learning system may also process the substantially real-time data through the machine learning model to determine similarities between the features, as represented in the machine learning model, determined to be most responsible for causing an occurrence of a wildfire in a geographic region similar to the particular geographic region corresponding to the substantially real-time data.

The similarity may be an exact match, or a value match within a threshold variance (e.g., a value match within about 25% variance, about 20% variance, about 15% variance, about 10% variance, about 5% variance, etc.). When the machine learning system determines via the machine learning model that a match exists between a programmed number of substantially-real time data points and the features determined to be most responsible for causing an occurrence of a wildfire, the machine learning model may determine that it is probable that a wildfire may occur (e.g., a wildfire is imminent and/or conditions are probable for the occurrence of a wildfire). In some examples, the machine learning model may provide a result or prediction of a wildfire in a binary format, indicating either that a fire is probable or a fire is not probable. In other examples, the machine learning model may provide the result or prediction as a percentage in a range of 0 to 100, where a larger value indicates a higher probability of a wildfire occurring.

At operation 306, a recommendation is determined. In some examples, the recommendation is the prediction determined by the machine learning model. In other examples, the prediction determined by the machine learning model may be processed by a probabilistic model to determine an action as the recommendation. The action may be, for example, to de-energize a power grid in an effort to reduce the probability of a wildfire occurring in the particular geographic region corresponding to the substantially real-time data.

At operation 308, the recommendation is output. In some examples, the recommendation is output by transmitting the recommendation via a network to a subscriber device as a notification of the probability of a wildfire occurring in the particular geographic region corresponding to the substantially real-time data. In other examples, the recommendation is output by controlling a computing device or other components of a power grid to de-energize in an effort to reduce the probability of a wildfire occurring in the particular geographic region corresponding to the substantially real-time data.

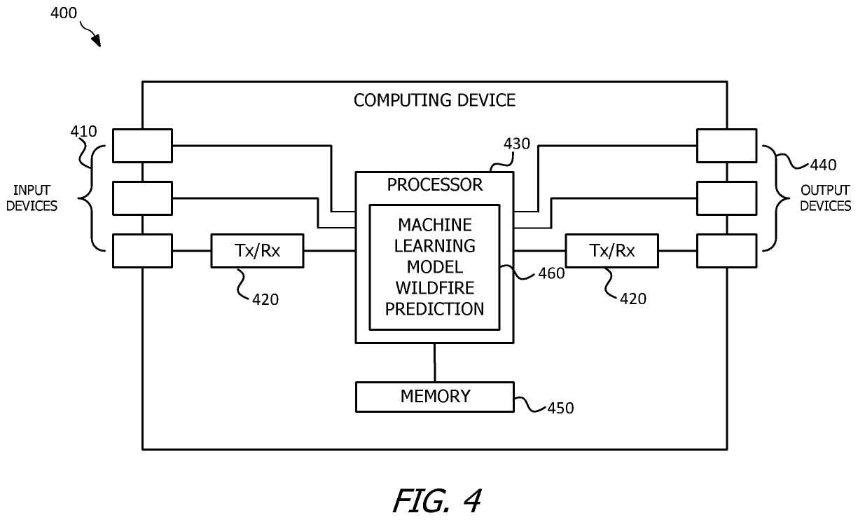

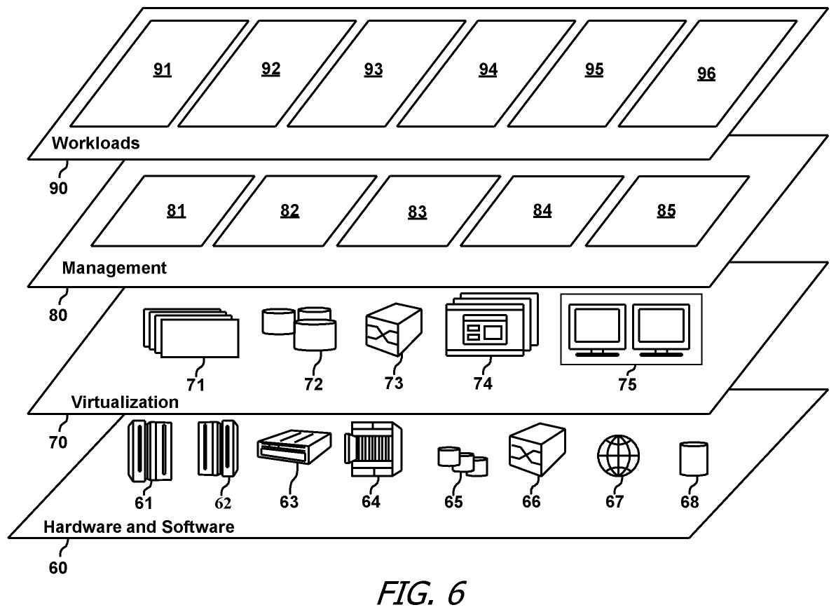

With reference now to FIG. 4, a schematic diagram of a computing device 400 according to various embodiments is shown. Computing device 400 may be any suitable processing device capable of performing the functions disclosed herein such as a computer system, a server, a cloud computing node (e.g., as discussed below with respect to FIG. 6 and/or FIG. 7), or may be generally representative of a distributed computing device in which one or more components of computing device 400 are distributed or shared across one or more devices. Computing device 400 is configured to implement at least some of the features/methods disclosed herein, for example, the machine learning model training and/or wildfire prediction of machine learning system 100 and/or methods 200 and/or 300, discussed above. In various embodiments, for instance, the features/methods of this disclosure are implemented using hardware, firmware, and/or software installed to run on hardware.

Computing device 400 is a device (e.g., an access point, an access point station, a router, a switch, a gateway, a bridge, a server, a client, a user-equipment, a mobile communications device, etc.) that transports data through a network, system, and/or domain, and/or provides services to other devices in a network or performs computational functions. In one embodiment, the computing device 400 is an apparatus and/or system configured to implement the machine learning model training and/or wildfire prediction of machine learning system 100 and/or methods 200 and/or 300, for example according to a computer program product.

The computing device 400 comprises one or more downstream ports 410 coupled to a transceiver (Tx/Rx) 420, which are transmitters, receivers, or combinations thereof. The Tx/Rx 420 transmits and/or receives frames from other computing devices via the downstream ports 410. Similarly, the computing device 400 comprises another Tx/Rx 420 coupled to a plurality of upstream ports 440, wherein the Tx/Rx 420 transmits and/or receives frames from other nodes via the upstream ports 440. The downstream ports 410 and/or the upstream ports 440 may include electrical and/or optical transmitting and/or receiving components. In another embodiment, the computing device 400 comprises one or more antennas coupled to the Tx/Rx 420. The Tx/Rx 420 transmits and/or receives data (e.g., packets) from other computing or storage devices wirelessly via the one or more antennas.

A processor 430 is coupled to the Tx/Rx 420 and is configured to train a machine learning model and/or determine a probability of a wildfire occurring based on processing via a machine learning model. In an embodiment, the processor 430 comprises one or more multi-core processors and/or memory modules 450, which functions as data stores, buffers, etc. The processor 430 is implemented as a general processor or as part of one or more application specific integrated circuits (ASICs), field-programmable gate arrays (FPGAs), and/or digital signal processors (DSPs). Although illustrated as a single processor, the processor 430 is not so limited and alternatively comprises multiple processors. The processor 430 further comprises processing logic configured to execute a machine learning model wildfire prediction computer program product 460 that is configured to determine a probability of a wildfire occurring in a geographic region of interest.

FIG. 4 also illustrates that a memory module 450 is coupled to the processor 430 and is a non-transitory medium configured to store various types of data. Memory module 450 comprises memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage is used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 450 may be used to house the instructions for carrying out the various embodiments described herein. For example, the memory module 450 may comprise the machine learning model wildfire prediction computer program product 460, which is executed according by processor 430.

It is understood that by programming and/or loading executable instructions onto the computing device 400, at least one of the processor 430 and/or the memory module 450 are changed, transforming the computing device 400 in part into a particular machine or apparatus, for example, a wildfire prediction device and/or a machine learning system having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable and will be produced in large volume may be preferred to be implemented in hardware (e.g., in an ASIC) because for large production runs the hardware implementation may be less expensive than software implementations. Often a design may be developed and tested in a software form and then later transformed, by design rules well-known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

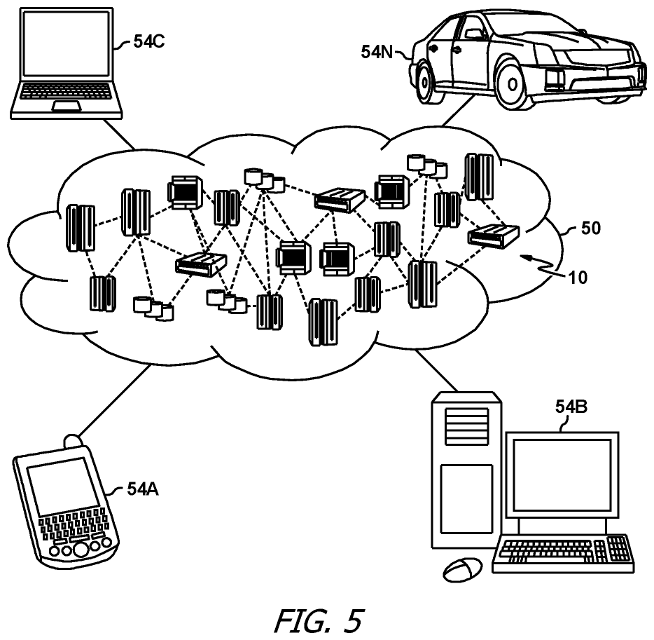

Turning now to FIGS. 5 and 6, it is to be understood that although this disclosure includes a detailed description related to cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

The cloud model characteristics may include on-demand self-service, broad network access, resource pooling, rapid elasticity, and/or measured service. On-demand self-service is a characteristic in which a cloud consumer can unilaterally provision computing capabilities, such as server time and network storage, as needed automatically without requiring human interaction with the service's provider. Broad network access is a characteristic in which capabilities are available over a network and accessed through standard mechanisms that promote use by heterogeneous thin or thick client platforms (e.g., mobile phones, laptops, and personal digital assistants (PDAs)). Resource pooling is a characteristic in which the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity is a characteristic in which capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service is a characteristic in which cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

The cloud model Service Models may include Software as a Service (SaaS), Platform as a Service (PaaS), and/or Infrastructure as a Service (IaaS).

SaaS is a service model in which the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. PaaS is a service model in which the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. IaaS is a service model in which the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

The cloud model Deployment Models may include private cloud, community cloud, public cloud, and/or hybrid cloud. Private cloud is a deployment model in which the cloud infrastructure is operated solely for an organization. It may be managed by the organization or a third party and may exist on-premises or off-premises. Community cloud is a deployment model in which the cloud infrastructure is shared by several organizations and supports a specific community that has shared concerns (e.g., mission, security requirements, policy, and compliance considerations). It may be managed by the organizations or a third party and may exist on-premises or off-premises. Public cloud is a deployment model in which the cloud infrastructure is made available to the general public or a large industry group and is owned by an organization selling cloud services. Hybrid cloud is a deployment model in which the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, PDA or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that cloud computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. The hardware and software components of hardware and software layer 60 may serve as the underlying computing components on which cloud computing functions are executed in response to receipt of a request for performance of a function and/or service offered as a part of cloud computing environment 50 such as, for example, the gesture meaning determination described below.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. These virtual entities may enable a subscriber to cloud computing environment 50 to interact indirectly with the hardware and software components of hardware and software layer 60 indirectly via virtual layer 70 without having a specific knowledge of, or interacting directly with, hardware and software layer 60. For example, a plurality of subscribers may interact with virtualization layer 70 to respectively access a corresponding plurality of virtual servers 71 and virtual storage 72 that all exist as separate threads, instances, partitions, etc. on a single server 62 and storage device 65, respectively. In such a scenario, virtualization layer 70 may cause each virtual server 71 and virtual storage 72 to appear to each subscriber as a dedicated and seamless computing and storage device, while enabling efficient operation of the hardware and software components of hardware and software layer 60 by reducing a potential for redundancy of components.

In one example, management layer 80 may provide the functions described below via an abstraction layer such that a subscriber to cloud computing environment 50 may interact with virtualization layer 70 and/or hardware and software layer 60 indirectly via management layer 80 without having a specific knowledge of, or interacting directly with, virtualization layer 70 and/or hardware and software layer 60. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA. Management layer 80 enables a subscriber to cloud computing environment 50 to interact with cloud computing environment 50 through management layer 80 to perform tasks and functions (e.g., administrative tasks) separate from actual execution of functions in the cloud computing environment 50. For example, an administrator may request access to a certain amount of computing resources (e.g., as provided in virtualization layer 70 and/or hardware and software layer 60) in cloud computing environment 50 via management layer 80 without having a specific knowledge of, or interacting directly with, virtualization layer 70 and/or hardware and software layer 60.

Workloads layer 90 provides examples of functionality for which the cloud computing environment may be utilized. The workloads and functions illustrated in workloads layer 90 are merely exemplary workloads and functions that may be executed in cloud computing environment 50 at the request or direction of a subscriber to cloud computing environment 50, and are not limited to those explicitly recited herein. Examples of workloads and functions which may be provided from this layer include: mapping and navigation 91; software development and lifecycle management 92; virtual classroom education delivery 93; data analytics processing 94; transaction processing 95; and wildfire prediction 96. These workloads and functions of workloads layer 90 may be end-user applications that enable a subscriber to cloud computing infrastructure 50 to interact with any of management layer 80, virtualization layer 70, and/or hardware and software layer 60 indirectly via workloads layer 90 without having a specific knowledge of, or interacting directly with, any of management layer 80, virtualization layer 70, and/or hardware and software layer 60. In this manner, the subscriber and/or an end user who accesses cloud computing infrastructure 50 may not require any form of specialized knowledge relating to the composition or operation of any of management layer 80, virtualization layer 70, and/or hardware and software layer 60 to perform the workloads and functions of workloads layer 90. In such a scenario, the workloads and functions of workloads layer 90 are said to be abstracted from management layer 80, virtualization layer 70, and hardware and software layer 60 because workloads layer 90 hides the underlying operation of management layer 80, virtualization layer 70, and hardware and software layer 60 from the subscriber and/or end-user while still enabling the subscriber and/or end-user to indirectly interact with management layer 80, virtualization layer 70, and/or hardware and software layer 60 to receive the computer processing benefits thereof via workloads layer 90.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer program product for prediction of a probability of a wildfire occurring, the computer program product comprising a computer readable storage medium having program instructions embodied therewith, the program instructions executable by a processor to cause the processor to:
receive one or more piece of historical data associated with one or more occurrences of wildfires;
train a machine learning model according to the received one or more historical data;
receive one or more piece of substantially real-time data associated with a region of interest; and
process the received one or more piece of substantially real-time data using the machine learning model to determine the probability of the wildfire occurring.

2. The computer program product of claim 1, wherein executing a set of instructions further causes a processor to transmit a notification to a user indicating the probability of the wildfire occurring.

3. The computer program product of claim 1, wherein executing a set of instructions further causes the processor to transmit a recommendation to a user to de-energize a power grid to reduce the probability of the wildfire occurring.

4. The computer program product of claim 1, wherein executing a set of instructions further causes the processor to transmit a command to cause a power grid to be de-energized to reduce the probability of the wildfire occurring.

5. The computer program product of claim 1, wherein training the machine learning model includes:
performing data pruning on the one or more piece of historical data to create a plurality of HashMaps, each HashMap corresponding to a particular geographic region;
performing a feature selection on each of the HashMaps to determine one or more data points included in each of the HashMaps representing one or more characteristics that most contribute to the one or more occurrences of wildfires; and
training the machine learning model according to the one or more data points included in each of the HashMaps representing characteristics that most contribute to the one or more occurrences of wildfires.

6. The computer program product of claim 5, wherein the one or more characteristics are one or more environmental characteristics including one or more weather conditions and one or more conditions of a power grid.

7. The computer program product of claim 1, wherein executing a set of instructions further causes the processor to execute a probabilistic model to determine a recommendation based on the probability of the wildfire occurring to mitigate the probability of the wildfire occurring.

8. A computer-implemented method, comprising:
receiving one or more piece of historical data associated with one or more occurrences of wildfires;
training a machine learning model according to the one or more piece of historical data;
receiving one or more piece of substantially real-time data associated with a region of interest; and
processing the one or more piece of substantially real-time data using the machine learning model to determine the probability of the wildfire occurring.

9. The computer-implemented method of claim 8, further comprising transmitting a notification to a user indicating the probability of the wildfire occurring.

10. The computer-implemented method of claim 8, further comprising transmitting a recommendation to a user to de-energize a power grid to reduce the probability of the wildfire occurring.

11. The computer-implemented method of claim 8, further comprising transmitting a command to cause a power grid to be de-energized to reduce the probability of the wildfire occurring.

12. The computer-implemented method of claim 8, wherein training the machine learning model includes:
performing data pruning on the one or more piece of historical data to create a plurality of HashMaps, each HashMap corresponding to a particular geographic region;
performing a feature selection on each of the HashMaps to determine one or more data points included in each of the HashMaps representing one or more characteristics that most contribute to the one or more occurrences of wildfires; and
training the machine learning model according to the one or more data points included in each of the HashMaps representing characteristics that most contribute to the one or more occurrences of wildfires.

13. The computer-implemented method of claim 12, wherein the one or more characteristics are one or more environmental characteristics including one or more weather conditions and one or more conditions of a power grid.

14. The computer-implemented method of claim 8, further comprising executing a probabilistic model to determine a recommendation based on the probability of the wildfire occurring to mitigate the probability of the wildfire occurring.

15. A machine learning system, comprising a processor configured to:
receive historical data associated with occurrences of wildfires;
train a machine learning model according to the historical data;
receive substantially real-time data associated with a region of interest; and
process the substantially real-time data using the machine learning model to determine the probability of the wildfire occurring.

16. The system of claim 15, wherein executing a set of instructions further causes the processor to transmit a notification to a user indicating the probability of the wildfire occurring.

17. The system of claim 15, wherein executing a set of instructions further causes the processor to transmit a recommendation to a user to de-energize a power grid to reduce the probability of the wildfire occurring.

18. The system of claim 15, wherein training the machine learning model includes:
performing data pruning on the one or more pieces of historical data to create a plurality of HashMaps, each HashMap corresponding to a particular geographic region;
performing a feature selection on each of the HashMaps to determine one or more data points included in each of the HashMaps representing one or more characteristics that most contribute to the one or more occurrences of wildfires; and
training the machine learning model according to the one or more data points included in the each of the HashMaps representing characteristics that most contribute to the one or more occurrences of wildfires.

19. The system of claim 18, wherein the one or more characteristics are one or more environmental characteristics including one or more weather conditions and one or more conditions of a power grid.

20. The system of claim 15, wherein executing a set of instructions further causes the processor to execute a probabilistic model to determine a recommendation based on the probability of the wildfire occurring to mitigate the probability of the wildfire occurring.
